(19) United States
(12) Patent Application Publication
(10) Pub. No.: US 2025/0087756 A1
(43) Pub. Date: Mar. 13, 2025

(54) ENERGY STORAGE DEVICES AND ASSOCIATED SYSTEMS AND METHODS

(71) Applicant: Microvast, Inc., Stafford, TX (US)

(72) Inventors: Tianjun Xie, Stafford, TX (US); Sangmin Lee, Stafford, TX (US); Bryan Yonemoto, Stafford, TX (US)

(21) Appl. No.: 18/466,739

(22) Filed: Sep. 13, 2023

(51) Int. Cl. H01M 10/058; H01M 4/04; H01M 4/131; H01M 4/1391; H01M 10/44; H01M 50/403; H01M 50/431

(52) U.S. Cl. CPC H01M 10/058; H01M 4/0416; H01M 4/131; H01M 4/1391; H01M 10/44; H01M 50/403; H01M 50/431

(57) ABSTRACT

An energy storage device is provided in the present technology. The energy storage device includes an anode having a p-type material, a cathode having a n-type material, and a separator disposed between the anode and the cathode, wherein the separator is composed of an insulating material, and wherein a valence band maximum (VBM) of the p-type material and a conduction band minimum (CBM) of the n-type material fall within an energy band gap of the insulating material.

### TECHNICAL FIELD

The present disclosure relates to energy storage devices and, in particular, to methods of designing and fabricating such energy storage devices.

### BACKGROUND

As we continue to move away from fossil fuels, the most familiar choice for energy storage are redox batteries that utilize moving ions to achieve energy storage. Lithium-ion batteries, for example, have been broadly utilized. Despite decades of research and technological breakthroughs, however, ion-based batteries reveal consistent problems, including slow diffusion rate and high sensitivity to temperatures that impact the device performance and cause safety concerns that prevent broader applications. In addition, lithium-ion batteries are expensive and require a significant amount of precious minerals such as cobalt and nickel. Moreover, lithium-ion batteries may only store enough energy for two to four hours at the large scale required. Conventional lithium-ion batteries may also wear out quickly and therefore require regular replacement with no systematic recycling pathways.

In comparison to traditional lithium-ion batteries, all-electron energy storage devices, such as all-electron batteries, do not rely upon moving ions to carry charges. Instead, electrons or holes presented in semiconductor materials can be utilized and responsible for rapid charge transfer in such energy storage devices. The electrons can act as negative charge carriers and the holes can act as positive charge carriers. Furthermore, semiconductor materials can be in the form of oxides such as functional metal oxides, and implemented as various components of the energy storage devices. The charge-transfer insulating properties of the oxides make the all-electron energy storage devices more resistant to thermal runaway, therefore safer and more reliable than traditional lithium-ion batteries.

For energy storage battery devices, an important performance criteria relates to a fraction of the full capacity available under specified conditions of discharge after being stored for a period of time, i.e., the battery charge retention. In many all-electron energy storage devices, charge retention can be problematic for semiconductor materials included therein. For example, upon removal of the external electric field applied to an all-electron energy storage battery device, p-n junctions formed in the battery may lose all the charges instantly due to rapid recombination of the holes and electrons. In addition, expensive material processing techniques associated with fabricating conventional all-electron energy storage device, e.g., sputtering, PVD, and ALD, are prohibitively expensive and time-consuming, thereby inhibiting large-scale manufacturing and commercialization.

### BRIEF DESCRIPTION OF THE DRAWINGS

FIG. 1 is a block diagram illustrating an energy storage device configured in accordance with one or more embodiments of the present technology.

FIG. 2 is a schematic view of an energy storage device under charging and discharging conditions in accordance with one or more embodiments of the present technology.

FIG. 3 illustrates energy bands of a P-type semiconductor, separator, and N-type semiconductor of an energy storage device configured in accordance with one or more embodiments of the present technology.

FIG. 4 is a display diagram illustrating an alignment of energy band structures among anode, separator, and cathode of an energy storage device configured in accordance with one or more embodiments of the present technology.

FIGS. 5A-5C illustrate Nyquist curves of energy storage devices having various configurations of anode, separator, and cathode and configured in accordance with one or more embodiments of the present technology.

FIG. 6 is a display diagram illustrating charge and rest curves of energy storage devices configured in accordance with one or more embodiments of the present technology.

FIG. 7 is a block diagram illustrating a workflow for designing energy storage devices configured in accordance with one or more embodiments of the present technology.

FIG. 8 is a partially schematic side view illustrating an assembled energy storage device in which some implementations of the disclosed technology can operate.

FIG. 9 is a flow chart illustrating a method of processing an energy storage device according to embodiments of the present technology.

FIG. 10 is a schematic view of a system including an energy storage device configured in accordance with embodiments of the present technology.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the drawings, the same reference numerals used in different embodiments designate like or corresponding, but not necessarily identical, elements.

### DETAILED DESCRIPTION

The present technology is generally directed to energy storage devices that rely upon moving electrons and holes in corresponding semiconductors and methods of designing and fabricating such energy storage devices. These all-electron energy storage devices can be made of three primary components: a cathode, a separator, and an anode. Each component of the disclosed energy storage devices can be prepared using a solution-based evaporation process. In some embodiments, the anode, separator, and cathode layers of the energy storage device have a total thickness equal to or below 300 μm. Further, in some embodiments, the materials design and search for the components of the energy storage devices can be done using computational calculations, such as a first principle based hybrid density functional theory (DFT) calculation.

With this material design, semiconductor materials having excess or free electrons can be selected as the cathode material (e.g., with n-type dopant or defect) and semiconductor materials having excess or free holes can be selected as the anode material (e.g., with p-type dopant or defect). In the present technique, the material selected for the separator may have a relative higher energy band gap so that it prevents recombination of electrons and holes at the separator's interfaces with the anode and the cathode. Under an external electric field, the insulating material of the separator can be polarized. Meanwhile, charge carriers such as electrons and holes can become mobile in the p-type semiconductor material of the anode and the n-type semiconductor material of the cathode, respectively. Further, the mobile electron and hole carriers can accumulate near the cathode-separator interface and anode-separator interface of the insulating separator layer. In this technology, the electronic structure of the separator is designed to be compatible with the electronic structures of the p-type semiconductor material and the n-type semiconductor material, which essentially enables charge carrier trapping. When the energy storage device charges, charge carriers become trapped near the junction-separator interface. When the energy storage device discharges, charge carriers become un-trapped and diffuse back to the bulk of p-type semiconductor material of the anode and the n-type semiconductor material of the cathode. The trapping mechanism, ideally shallow trapping, requires a very specific energy lineup of materials adopted in components of the energy storage devices. Computational studies using first-principles calculations, e.g., DFT, has been adopted to address this issue by providing a pool of candidate materials and their bandgap information. Further, this technique provides guidance on selecting candidate materials through aligning their energy band gaps so as to form a desired trapping zone in the separator. Moreover, the present technique is expected to provide a comprehensive library of possible working pairs of candidate materials. Many of candidate materials used for the energy storage devices of the present technique are common and affordable chemicals, making the disclosed all-electron energy storage devices feasible for large volume production.

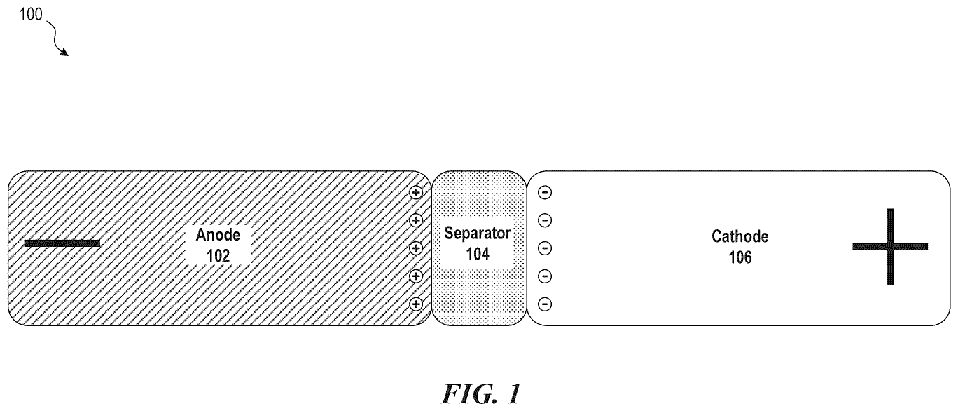

FIG. 1 is a block diagram illustrating an all-electron energy storage device 100 configured in accordance with one or more embodiments of the present technology. The energy storage device 100 comprises battery cell components including an anode 102, a separator 104, and a cathode 106, disposed from left to right as shown in FIG. 1. In this energy storage device 100, each one of the anode 102, the separator 104, and the cathode 106 are semiconductors, and can be made of oxides, e.g., semiconductor oxides. Mobile carriers included in the energy storage device 100 include electrons and holes, which can be transmitted through the components of the energy storage device 100 and an external circuit.

The anode 102 of energy storage device 100 can be made of a p-type semiconductor material including, but not limited to, silicon, TiO₂, SnO, and NiO. The anode 102 can be formed, for example, by doping a trivalent impurity such as gallium or indium into a pure semiconductor material to create holes. During a discharge phase (power output), holes can be released from the anode 102 and/or the separator 104 and diffuse back to the bulk material. The cathode 106 can be composed of a n-type semiconductor material including, but not limited to, silicon, TiO₂, PbO, ZnO, CoO, and other functional oxides. The cathode 106 can be formed, for example, by implanting dopant atoms having more electrons in their outer shell into a pure semiconductor material to create excess electrons for conducting current. During the discharge phase, holes from the anode 102 may be combined with electrons from the cathode 106 from the external circuit at the anode 106, resulting in the release of energy. In additional embodiments, the anode 102 and/or the cathode 106 may be composed of different materials and/or formed using different techniques.

As shown in the embodiment illustrated in FIG. 1, the separator 104 is disposed between the anode 102 and cathode 106. In this example, the separator 104 can be oxide materials including, but not limited to, SiO₂, TiO₂, and ZrO₂. The separator 104 can be implemented here, for example, as a thin insulating layer placed between the anode 102 and the cathode 106 to prevent direct contact and short-circuits of the hole carriers and electron carriers. In this embodiment, the separator 104 has a thickness equal to or less than 200 μm to ensure effective trappings of the holes and electrodes. In other embodiments, the separator 104 may have a different thickness, be composed of different materials, and/or be fabricated using different techniques.

During a charging process of the energy storage device 100, the direction of current therein can be reversed. In particular, when an external voltage is applied to the energy storage device 100, excess or free holes can be accumulated in the anode 102 and excess or free electrons can be accumulated in the cathode 106, as opposing sides of the separator 104. The recombination of excess holes of the anode 102 and excess electrons of the cathode 106 can be prevented by the insulating layer 104.

The battery architecture of all-electron energy storage device 100 is expected to provide several advantages over conventional lithium-ion batteries, including increased energy density, elimination of battery breathing (e.g., volume expansions/contractions with cycle), enhanced reliability at higher operating temperatures, and the elimination of flammable liquid electrolytes. In addition, there are no restrictions on the form of the anode 102, the separator 104, and the cathode 106, i.e., powder or crystalline semiconductor layers can both work in forming components of the all-electron energy storage device 100.

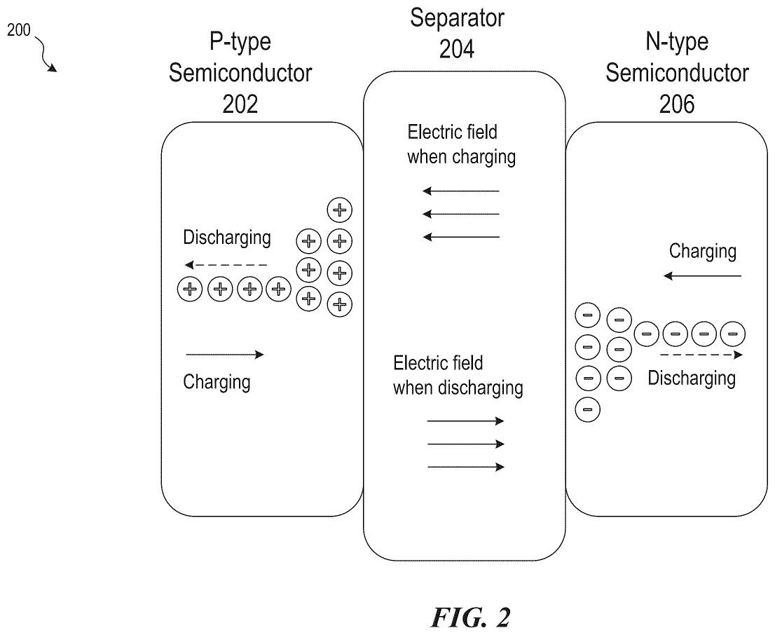

In the present technology, the charging and discharging mechanism of the all-electron energy storage devices involves movement of both free electrons and holes in the battery system. The all-electron energy storage devices disclosed herein are rechargeable and utilize both ion transfer and electron transfer processes to store and release energy. FIG. 2, for example, is a schematic view of an all-electron energy storage device 200 under charging and discharging conditions and configured in accordance with one or more embodiments of the present technology. Similar to the energy storage device 100 illustrated in FIG. 1, the all-electron energy storage device 200 comprises battery components including a p-type semiconductor 202, a separator 204, and a n-type semiconductor 206 horizontally aligned and in physical contact with each other.

During the discharging phase, electrons flow from a negative electrode (cathode n-type semiconductor 206) of the energy storage device 200 to a positive electrode (anode p-type semiconductor 202) of the energy storage device 200 through an external circuit. Simultaneously, holes move from the anode trap to the bulk of p-type semiconductor 202, enabling recombination of the electrons and holes. In the discharging phase, the internal electric field of the energy storage device 200 is from the anode p-type semiconductor 202 to the cathode n-type semiconductor 206. To recharge the energy storage device 200, during the charging phase, an external power source (e.g., a charger) can be connected to the energy storage device 200. This charging process reverses the discharging phase. For example, electrons now flow from the charger into the cathode (the cathode n-type semiconductor 206) of the energy storage device 200, to accumulate excess or free electrons at the interface of cathode 206 and the separator 204. Meanwhile, holes accumulate form the bulk of the anode (the anode p-type semiconductor 202) of the energy storage device 200 to accumulate excess or free holes at the interface of anode 202 and the separator 204.

When charging the all-electron energy storage device 200, charge carriers (namely the electrons and holes) will migrate and accumulate respectively in the cathode 206 and anode 202 due to the polarization on the separator 204. When the all-electron energy storage device 200 is discharging, charge carriers including holes and electrons will diffuse back to the bulk of the semiconductor components of the battery device. Charge retention, i.e., the ability of battery device to retain its stored carriers including holes and electrons over time, can be enabled when there are shallow traps created in the separator 202.

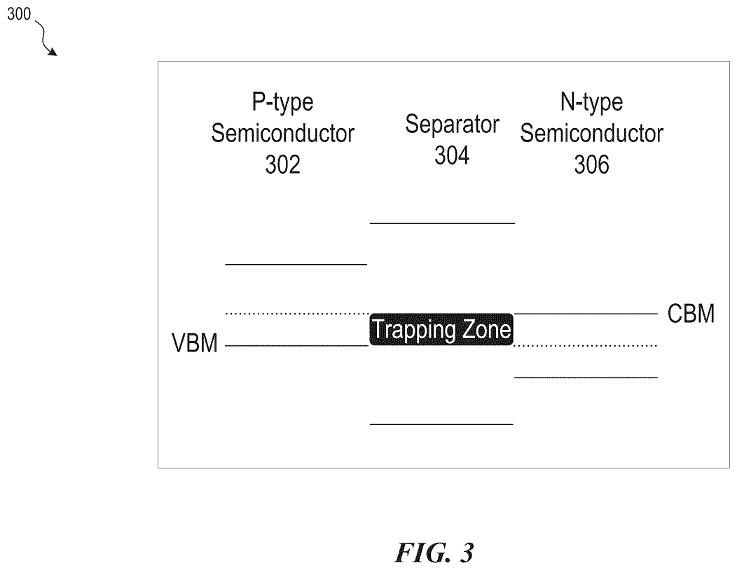

In semiconductor materials, the energy bands play an important role in understanding their electronic properties. The semiconductor materials in the all-electron energy storage devices of the present technology are formed by arranging the energy levels of the electrons and holes within the materials. There are two primary energy bands—a valence band and a conduction band—for each of the semiconductor materials and oxide materials of the all-electron energy storage devices disclosed herein. Specifically, the valence band is a highest energy band (i.e., the valence band maximum, “VBM”) that is fully occupied by electrons at absolute zero temperature and represents the energy levels of electrons tightly bound to their respective atoms and are not free to move. The conduction band (i.e., the conduction band minimum, “CBM”) is the energy band above the valence band. In contrast to the valence band, the conduction band can be empty or partially filled by electrons that have a higher energy and are free to move within the material. There is a bandgap between the valance band and the conduction band. The bandgap is the energy range required for an electron to transmit from the VBM to the CBM. The bandgap may be large for insulating materials and relatively small for semiconductor materials. In fact, the profile and dimension of the bandgaps of semiconductor materials and oxide materials adopted for the all-electron energy storage device determines its performances. FIG. 3 illustrates the mechanism of forming shallow traps within a trapping zone of the all-electron energy storage device configured in accordance with the present technology. Specifically, FIG. 3 illustrates energy bands of a p-type semiconductor 302, a separator 304, and a n-type semiconductor 306 of an energy storage device 300 configured in accordance with one or more embodiments of the present technology. Similar to the all-electron energy storage devices 100 and 200 described above with reference to FIGS. 1 and 2, the separator 304 is disposed between the anode p-type semiconductor 302 and the cathode n-type semiconductor 306.

When a p-type semiconductor material (e.g., the anode material 302) is disposed next to a n-type semiconductor material (e.g., the cathode material 306) to form a p-n junction, a depletion region may be formed at the interface due to diffusion and recombination of charge carriers. To prevent the diffusion and recombination of hole carriers and electron carriers, the separator 304 can be disposed between the anode 302 and the cathode 306. In addition, and as shown in FIG. 3, the valence band and conduction band of the anode p-type semiconductor 302 can be respectively higher than that of the cathode n-type semiconductor 306, due to the differences in the work function and fermi levels of these two types of materials. Specifically, for the configuration of the all-electron energy storage devices, the VBM of the anode p-type semiconductor 302 is lower than CBM of the cathode n-type semiconductor 306, so that a trapping zone can be formed in the separator 304 between the anode and cathode. With this configuration, the energy difference of the trapping zone prevents electron flow from the valence band of the p-type semiconductor material 302 to the conduction band of the n-type semiconductor material 306. Specifically, electron trapping that occurs on the p-type semiconductor 302 immobilizes the electrons near its VBM, while hole trapping that occurs on the n-semiconductor 306 immobilizes the holes near its CBM.

The trapping zone formed in the separator 304 corresponds to the energy bands of the p-type semiconductor material 302 and n-type semiconductor material 306 that are adopted in the all-electron energy storage device 300. For example, the trapping zone can be defined by the VBM of the p-type semiconductor material 302 and the CBM of the n-type semiconductor material 306. In some embodiments, the range of energy trap [p-VBM, n-CBM] can be approximately 4 kT (6.576×10⁻²⁰ J) per electron at room temperature. In other embodiments, however, this range can vary. It will be appreciated that deep trapping zones are not desired in the present technology, as it is expected that they may lead to emission instead of charge diffusion.

To improve the charge retention of the all-electron energy storage device 300, energy levels of the p-type semiconductor material 302 and n-type semiconductor material adopted in the device 300 has to be coordinated. For example, the VBM of the p-type semiconductor material 302 as the anode should be lower than the CBM of the n-type semiconductor material 306 as the cathode. In addition, the energy levels of the n-type and p-type semiconductor materials of the device 300 need to be coordinated with the energy levels of the separator 304. For example, the band gaps of the separator 304 needs to be wide enough to house the trapping zone, as well as the band gaps of the p-type semiconductor material 302 and the n-type semiconductor material 306, and therefore insulating the semiconductor materials to prevent instant carrier recombination. In another example, the range of energy trap [p-VBM, n-CBM] should fall within the band gap of the separator 304 material, ideally near its own VMB or CMB levels, to maximize trapping and avoid current leaking due to conduction. In some embodiments, for example, the trap depth of the trapping zone in the separator 304 can be between 2 kT per elemental charge to 6 kT per elemental charge, so as to maximize the capacity while avoiding forming deep traps in the all-electron energy storage device 300.

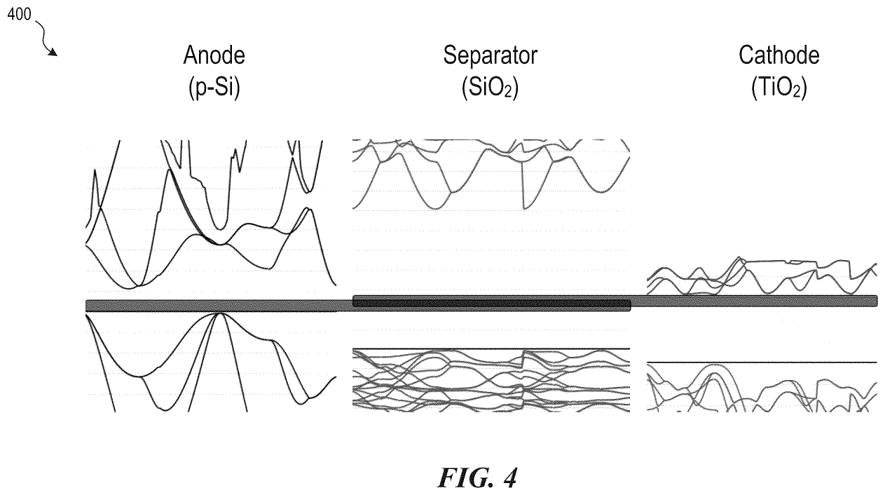

FIG. 4 is a display diagram illustrating an alignment of anode, separator, and cathode of an all-electron energy storage device 400 configured in accordance with one or more embodiments of the present technology. In this embodiment, the anode, separator, and the cathode of the energy storage device 400 are made of p-type silicon, SiO₂, and TiO₂, respectively. Here, the energy bands of corresponding anode p-Si, separator SiO₂, and cathode anatase TiO₂ are simulation results obtained from hybrid DFT calculations with the Heyd-Scuseria-Ernzerhof exchange-correlation functional (HSE06).

In FIG. 4, the energy bands alignments are illustrated in rectangular boxes. First, the VBM edge of p-Si anode material is close to and lower than the CBM edge of anatase-TiO₂ cathode material. In addition, the trap range of the trapping zone (shown as overlapped rectangular boxes region) formed between the p-Si and TiO₂, i.e., [p-VBM, n-CBM], falls within the band gap of separator SiO₂. Furthermore, the trap range is close to the proximity of VBM edge of the separator SiO₂. It can be found that the semiconductor material as well as oxide material cannot be arbitrarily selected for the all-electron energy storage device 400. To achieve a stable energy storage, the trapping zone can only be formed when specific energy band requirements are met in the energy storage device. Such information in general is not readily available from experiments. Accordingly, computational studies are of great advantage in obtaining the perspective discussed above. A library of exemplary materials that can be configured as anode, separator, and cathode for all-electron energy storage devices are provided in a later section based on first-principle DFT calculations.

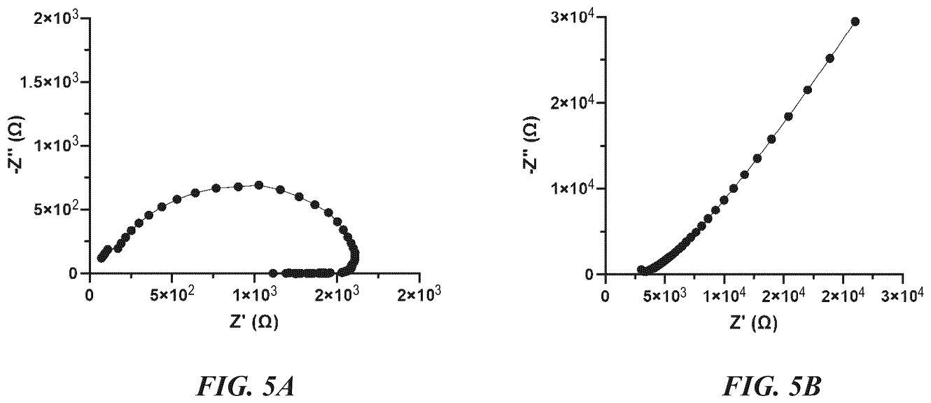

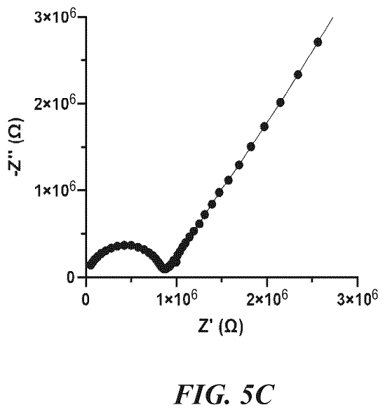

The energy storage ability of the all-electron energy storage device varies in accordance with the materials adopted for each component of the battery device. FIGS. 5A-5C, for example, illustrate non-destructive electrical impedance test results of energy storage devices having various configurations of anode, separator, and cathode in accordance with one or more embodiments of the present technology. Specifically, each of the energy storage devices may include various materials between Swagelok cell collectors used in the energy storage device assembly. The test generates Nyquist curves that plot the impedance of energy storage device in logarithmic scales. During the test, a small AC signal can be applied to the energy storage device under test, and resulting voltage and current responses can be measured. Specifically, Nyquist curves can be constructed through analyzing the frequency-dependent impedance values. In this experiment, the electrical impedance of energy storage device is measured with frequency of 1 to 1×10⁵ Hz.

A first test energy storage device only contains p-Si between the Swagelok cell current collectors. FIG. 5A illustrates a Nyquist plot corresponding to the first test energy storage device. It can be found that a semicircle has been formed. The semicircle plot confirms that energy storage device presents charge transfer resistance. However, there is no sign of diffusion resistance in the Nyquist plot. Therefore, the energy storage device having p-Si in its anode, separator, and cathode does not have a storage capability.

A second test energy storage device only contains SiO₂ between the Swagelok cell current collectors. FIG. 5B illustrates a Nyquist plot corresponding to the second test energy storage device. It can be found that the Nyquist plot only includes a linear portion. This Nyquist curve presents a sign of diffusion resistance and resembles as a dry capacitor only.

A third test energy storage device contains p-Si, SiO₂, and TiO₂ for its anode, separator, and cathode, respectively. In the corresponding Nyquist plot shown in FIG. 5C, both semicircle and linear extension are observed, which confirms that charge transfer resistance and diffusion resistance are presented in the energy storage device being tested. As shown in FIG. 5C, the diameter of the semicircle is related to the energy storage device's overall impedance, while the center of the semicircle represents a charge-transfer resistance. According to the Nyquist plot of the third test device, the third energy storage device including p-Si, SiO₂, and TiO₂ for its anode, separator, and cathode, respectively, behaves like a battery and is capable of holding charge.

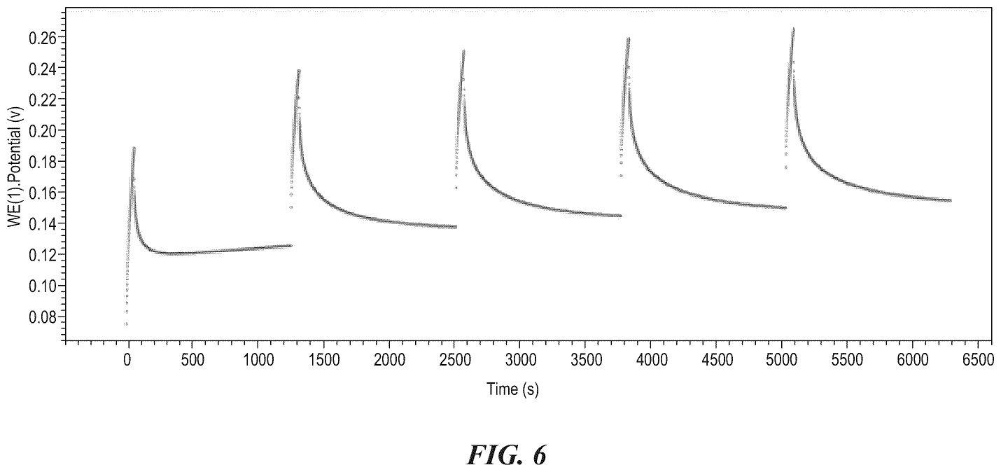

Besides the above electric impedance tests, and to further demonstrate the ability to retain charges as an energy storage device, the inventors of the present technology conducted a charge and rest test on an all-electron energy storage device configured in accordance with an embodiment of the present technology. The test was conducted, in part, using Autolab Echem Equipment commercially available from Metrohm AG Instruments. FIG. 6 illustrates charge and rest curves of the above-noted third energy storage device that includes p-Si, SiO₂, and TiO₂ for its anode, separator, and cathode, respectively. In this test, the third energy storage device was tested with 5 charge/rest cycles, each cycle consisting of 1 min of charging and 20 min of resting. Upon 1 min charging, the galvanostatic curve resets to 0 A to rest. Upon current cutoff, the all-electron energy storage device experienced initial voltage drops, while staying reasonably level throughout the remainder of the 20 min rest period, thus demonstrating stable charge retention.

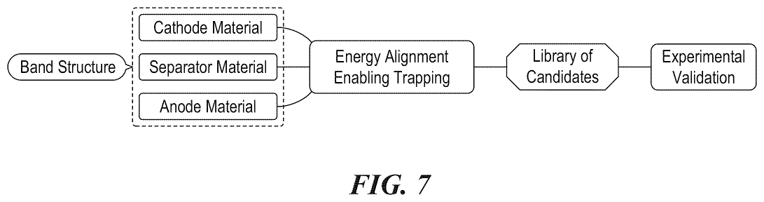

FIG. 7 is a block diagram illustrating a workflow for designing energy storage devices configured in accordance with one or more embodiments of the present technology. It will be appreciated that while FIG. 7 illustrates a series of steps associated with a particular workflow, in other embodiments, the disclosed workflow/process may include different or additional steps and/or may not include one or more of the steps described herein.

As shown in FIG. 7, the design of all-electron energy storage devices can start from a broad search of semiconductor materials. Various semiconductor materials can be adopted to form the anode, separator, and cathode of target energy storage devices. In addition, oxide material, such as functional oxide material, can be considered for the separator layer of energy storage devices. Here, the semiconductor material can include different dopants, including p-type dopants of Group III elements and n-type dopants of Group VI elements. To select proper materials for each of the anode, separator, and cathode of the energy storage devices, the energy band structure of the materials needs to be further considered. For example, energy band structure information relates to the valence band, the conduction band, and fermi level of a candidate semiconductor material need to be evaluated.

Once the candidate materials and energy band structure information of the candidate materials are obtained, the candidate materials can be each assigned to corresponding components of the target energy storage device (e.g., the anode, separator, and the cathode). The process of FIG. 7 also includes checking the energy level alignment among the materials selected for the target energy storage device to discover appropriate working pairs of materials that can enable carrier trappings at the separator of the energy storage device.

In one embodiment, for example, the valence band energy level of a candidate anode material can be compared with the conduction band energy level of a candidate cathode material. In addition, it is preferred to have the valence band of the candidate anode material lower than the conduction band of the candidate cathode material. For example, p-Si and anatase TiO₂ may be selected for the anode and cathode, respectively, of a target energy storage device. With this material selection, the energy band structure information of p-Si and anatase TiO₂ can be further reviewed and evaluated. Specifically, the workflow process can include determining whether the VBM of the p-Si is lower than the CBM of the anatase TiO₂ to form electron trapping at a separator layer interface of the target energy storage device. In other embodiments, at least one of the anode, separator, and the cathode can be made of oxide materials.

Furthermore, the energy band structure of a candidate separator material should be evaluated as part of the workflow process. For example, the separator material can be reviewed in accordance with the energy band structure of the candidate anode and cathode materials. For example, the energy band gap of the candidate separator material should be large enough to have the VBM of the candidate anode material and CBM of the candidate cathode material to fall therein. As describe above with reference to FIG. 4, the P-VBM and N-CBM define a lower limit and an upper limit, respectively, of the trapping zone, which is disposed within the bandgap of the candidate separator material. For example, once the p-Si and anatase TiO₂ are selected as anode material and cathode material, respectively, of a target energy storage device, SiO₂ can be reviewed and evaluated as the separator material disposed therebetween. As shown in FIG. 4, SiO₂ has an energy band gap within which the VBM of p-Si and CBM of anatase TiO₂ fall. The overlapped rectangular shape region of FIG. 4 represents the trapping zone, which is contained in the energy band gap of SiO₂ as a candidate separator material. In some other embodiments, however, the energy band gap value of the separator can be from 120% to 300% to that of the anode or the cathode.

Referring again to the workflow illustrated in FIG. 7, the candidate anode materials, separator materials, cathode materials, and their pairing relationships can be saved in a library of candidates for the design of additional energy storage devices. Based on the library of candidate materials working pairs, experiments can be conducted for further testing and validation of target energy storage devices. For example, a DFT simulation can be conducted to simulate the energy band gap alignment of the target energy storage device having the candidate material working pair implemented. In one embodiment, for example, a high throughput first-principles simulation can be performed by the Vienna ab initio simulation package (e.g., Version of VASP-6.3.1), which is a commercial package implemented DFT via plane wave basis and projector augmented wave (PAW) representation. A Perdew-Burke-Ernzerhof (PBE) functional for the generalized gradient approximation (GGA) can be utilized to process the electron exchange-correlation energy. In this example, the cutoff for the plane wave kinetic energy can be set to 520 eV. In addition, a Monkhorst-Pack scheme can be used to construct k-points grids for the Brillouin zone sampling, with automatic meshing density at a minimum of 1600 each modeled system. Here, the atomic positions and lattice parameters can be fully optimized with the DFT. In other embodiments, other suitable simulation techniques/applications may be utilized to perform the above-described experiments.

In some embodiments, the calculations involved for designing energy storage devices can be performed under a spin-polarization scheme, including ferromagnetic and antiferromagnetic configurations. The electronic convergence can be set as 1e⁻⁰⁷ eV. The ionic convergence criterion, the Hellmann-Feynman force, can be set as 0.01 eV/Å. Once all atomic structures of candidate materials are optimized, band structure calculations can be carried out using the Heyd-Scuseria-Ernzerhof (HSE) hybrid functional. The obtained band structures of candidate materials can be used for screening for potential working material pairs based on their energy band lineup, as demonstrated on FIGS. 3, 4, and 7.

Guided by the experimental validation described previously with respect to the workflow of FIG. 7, such as the hybrid DFT calculations, a group of candidate materials combinations can be identified for configuring a target energy storage device. For example, Table I (see below) presents a list of 26 feasible combinations of candidate materials that can be used to form an anode, separator, and cathode of an energy storage device. Each of the candidate material combinations exhibits proper lineups of energy band levels and features a trapping zone depth close to 4 kT per electron at room temperature. An exemplary combination of candidate materials selected for components of the energy storage device is p-Si, SiO₂, and TiO₂, shown as the first combination on Table I. Referring again to FIG. 7, p-Si, SiO₂, and TiO₂ can be selected from the library of candidate materials for the anode, separator, and cathode of the energy storage device, and then sent for the experimental validation to confirm that a trapping zone can be formed at polarized separator surfaces to enable energy storage functions. In some other embodiments, candidate materials can be selected to form a trapping zone having energy depth ranging from 2 kT per electron to 6 kT per electron.

TABLE I
Library of Candidate Materials for All Electron Energy Storage Device

| | P-type Material | Oxide Material | N-type Material |
|---|---|---|---|
| Combination | (Anode) | (Separator) | (Cathode) |
| 1 | Si | SiO₂ | TiO₂ |
| 2 | Si | SiO₂ | Bi₄O₇ |
| 3 | Si | SiO₂ | Pb₂O₃ |
| 4 | Si | SiO₂ | Sb₂O₅ |
| 5 | Si | SiO₂ | Ga₂O₃ |
| 6 | Si | SiO₂ | PbO |
| 7 | Si | SiO₂ | CoO |
| 8 | TiO₂ | SiO₂ | WO₃ |
| 9 | TiO₂ | SiO₂ | Nb₂O₅ |
| 10 | TiO₂ | SiO₂ | WO₃ |
| 11 | TiO₂ | SiO₂ | Rb₂O |
| 12 | TiO₂ | SiO₂ | Cs₂O |
| 13 | TiO₂ | SiO₂ | ZnO |
| 14 | TiO₂ | SiO₂ | HgO |
| 15 | Si | TiO₂ | Bi₄O₇ |
| 16 | Si | TiO₂ | Pb₂O₃ |
| 17 | Si | TiO₂ | Sb₂O₅ |
| 18 | Si | TiO₂ | Ga₂O₃ |
| 19 | Si | TiO₂ | PbO |
| 20 | Si | TiO₂ | CoO |
| 21 | SnO | SiO₂ | Si |
| 22 | SnO | TiO₂ | Si |
| 23 | SnO | ZrO₂ | Si |
| 24 | NiO | SiO₂ | Si |
| 25 | NiO | TiO₂ | Si |
| 26 | NiO | ZrO₂ | Si |

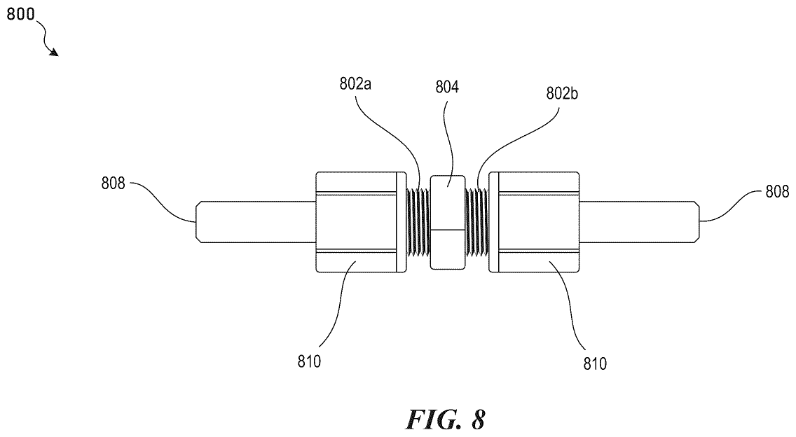

Once the candidate materials are selected for the anode, separator, and cathode of a target energy storage device, such materials can be processed accordingly and assembled in a battery cell to form an all-electron energy storage device configured in accordance with the present technology. FIG. 8, for example, is a partially schematic side view illustrating an assembled energy storage device 800 in which some implementations of the disclosed technology can operate. In this example, a Swagelok-type cell can be used to assemble components of the all-electron energy storage device. The Swagelok cell illustrated in FIG. 8 includes two stainless dowel pins 808 disposed at opposing ends of the device, a pair of sealing rings 810 respectively associated with corresponding stainless dowel pins 808, and a compression tube fitting 804 disposed between the pair of scaling rings 810. In this example, the two stainless dowel pins 808 can extend from opposite ends of a main tube, on which the sealing rings and compression tube fitting are disposed. As shown in FIG. 8, the anode of the energy storage device 800 (e.g., p-type semiconductor material) can be assembled in the portion of main tube 802a, being disposed between the left sealing ring 810a and the compression tube fitting 804. In comparison, the cathode of the energy storage device 800 (e.g., n-type semiconductor material) can be assembled in the portion of the main tube 802b, being disposed between the right sealing ring 810b and the compression tube fitting 804. The separator (e.g., oxide material) can be assembled in the main tube 802 and under the compression tube fitting 804. This way, the anode, separator, and cathode can be all assembled in the main tube 802 and in intimate contact with each other. In other embodiments, the Swagelok battery cell assembly shown in FIG. 8 can also be used for electrochemical impedance spectroscopy measurements.

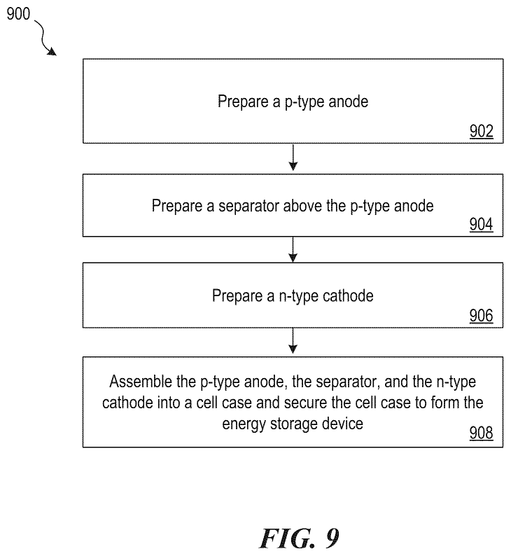

FIG. 9 is a flow chart illustrating a method 900 of processing an energy storage device according to embodiments of the present technology. The method 900 begins at block 902 with preparing a p-type anode. For example, a p-type semiconductor layer can be coated on a substrate to form a p-type anode for a battery device. In some other embodiments, p-Si anode can be formed from a silicon wafer. For example, Group III elements (e.g., boron) can be doped into a silicon wafer to form a p-Si wafer. In some embodiment, the doping level of boron can be close to 1 ppm and the ohmic resistance of p-Si wafer can be around 1 ohm/cm. Here, the p-type anode may have a thickness equal to or less than 300 μm. Candidate materials for forming the p-type anode includes silicon, TiO₂, SnO, NiO, and any other feasible p-type semiconductor materials. In other embodiments, however, the preparation of the p-type anode at block 902 can include different materials and/or different arrangements.

At block 904, the method 900 includes preparing a separator above the p-type anode. For example, an oxide layer can be coated on the p-type anode formed using the above-described methods. In some embodiments, the separator may be present in a powder form or a continuous thin film form. Specifically, the separator layer can be processed through a solution-based evaporation process. For example, a SiO₂ layer can be fabricated as a separator of the all-electron energy storage device. In one embodiment, SiO₂ powder with compound purity higher than 99.5% can be adopted for the separator preparation. In general, the SiO₂ powder for the separator processing should have a particle size (average diameter) ranging from 30 μm to 80 μm. In one particular embodiment, 0.1081 g SiO₂ powder can be measured and suspended in a solvent such as 2 mL isopropyl alcohol (IPA). Once the suspensions are fully mixed, a gel-like SiO₂ solutions can be titrated by an equal amount of 0.0385 mL. The SiO₂ solution can be evaporated on an electrode. In this example, the SiO₂ solution can be coated on a p-Si anode electrode through a solution-based evaporation process. A number of suitable techniques, such as spin coating, dip coating, inkjet printing, or spray coating, can be utilized to dispose the SiO₂ solution on the electrode. After deposition, the SiO₂ layer can be subjected to a controlled evaporation process to allow the solvent to evaporate. As the solvent evaporates, the SiO₂ layer is formed on the electrode (e.g., the p-Si anode). In some embodiments, an additional step of thermal treatment such or annealing may be required to improve the separator layer quality. For example, an air drying process (e.g., three hours of air drying) can be conducted to form a uniform SiO₂ separator film. Here, the separator SiO₂ layer may include a plurality of SiO₂ particles having an average diameter that ranges from 30 μm to 80 μm. In other embodiments, the preparation of the separator above the p-type anode at block 904 can include different materials and/or different techniques.

The method 900 continues at block 906 with preparation of a n-type cathode. For example, a n-type semiconductor material can be selected from a silicon wafer. In another example, the n-type semiconductor material can be in a form of oxide thin film disposed on a current collector. The processing of the n-type cathode can also utilize the solution-based evaporation process described above. In one embodiment, for example, a TiO₂ layer can be formed as a cathode of the energy storage device. The processing of the TiO₂ layer can start from TiO₂ powder having a purity higher than 99.5%. In general, the TiO₂ powder for the cathode processing preferably has a particle size (average diameter) ranging from 30 μm to 80 μm. In one specific embodiment, 0.6848 g TiO₂ powder can be measured and suspended in a solvent such as 2 mL isopropyl alcohol (IPA). Once the suspensions are fully mixed, a gel-like TiO₂ solutions can be titrated by an equal amount of 0.0385 mL. Here, the TiO₂ solution can be evaporated on the current collector or on the separator. In this example, the TiO₂ solution can be coated on an electrode through the above-described solution-based evaporation process. Any suitable technique, such as spin coating, dip coating, inkjet printing, or spray coating, can be utilized here to dispose the TiO₂ solution on the electrode. After deposition, the TiO₂ layer can be subjected to a controlled evaporation process to allow the solvent to evaporate. As the solvent evaporates, the TiO₂ layer can be formed on the electrode (e.g., current collector). In some cases, an additional step of thermal treatment such or annealing may be required to improve the separator layer quality. For example, an air drying process (e.g., three hours of air drying) can be also conducted to form a uniform TiO₂ cathode layer. In other embodiments, the preparation of the n-type cathode at block 906 can include different materials and/or different techniques.

Lastly, at block 908, the method 900 includes assembling the p-type anode, the separator, and the n-type cathode into an energy storage cell case to form the energy storage device. For example, the p-Si wafer, SiO₂ separator layer coated above the p-Si wafer, and TiO₂ cathode disposed on current collector can be assembled into the Swagelock cell and secured to form the energy storage device (as described above with reference to FIG. 8). In one embodiment, each of the anode, the separator, and the cathodes may have a thickness equal to or less than 300 μm. In other embodiments, however, the components may have different dimensions.

In some embodiments, the method 900 of processing an energy storage device starts from preparing the n-type cathode. For example, a n-type semiconductor material can be selected or prepared as the n-type cathode. In addition, a separator material can be coated above the n-type cathode. For example, an oxide layer can be coated on the n-type cathode. Next, a p-type anode can be formed from a p-type semiconductor material including a silicon wafer or corresponding oxide materials. In some other embodiments, the method 900 of processing an energy storage device includes processing the n-type cathode, separator, and p-type anode separately. For example, each one of the n-type cathode, separator, and p-type anode can be fabricated simultaneously and then stacked together to form the energy storage device.

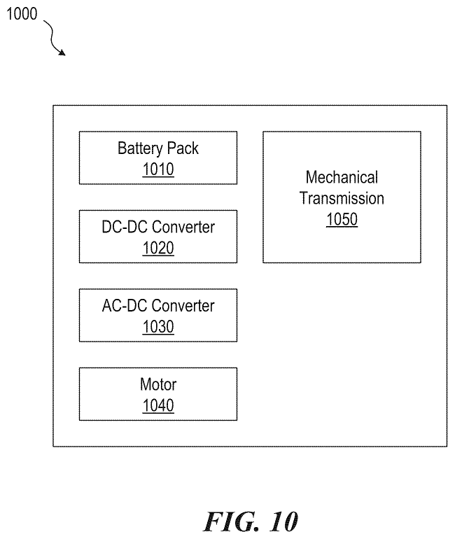

Any one of the energy storage devices described herein can be incorporated into any of a myriad of larger and/or more complex systems. FIG. 10, for example, is a representative example of such a system 1000. The system 1000 can include a battery pack 1010, a DC-DC converter 1020, an AC-DC converter 1030, a motor 1040, and/or other mechanical transmission 1050. The battery pack 1010 can include features generally similar to those of the all-electron energy storage devices described herein and can therefore include the anode, separator, and cathode materials described in accordance with the present technology. The system 1000 can perform any of a wide variety of functions, such as energy storage and power delivery, that requires high energy density and rechargeability. In addition, the battery pack 1010 of the system 1000 can be configured in series or parallel arrangements to achieve a desired voltage and capacity requirements for specific applications. The DC-DC converter 1020 can be coupled with the battery pack 1010 and configured for voltage level conversion for specific voltage outputs and voltage stabilization. In addition, the AC-DC converter 1030 can be also coupled with the battery pack 1010, and configured to convert alternating current from a main power source into direct current to charge the battery pack 1010. In the system 1000, the battery pack 1010, serving as a power source, can be coupled to a motor 1040 or any other mechanical transmission 1050 to deliver electrical energy in the forms of current. The components of the system 1000 can also include remote devices and any of a wide variety of computer-readable media and controlling processors.

Specific details of several embodiments of semiconductor devices, and associated systems and methods, are described Above. A person skilled in the relevant art will recognize that suitable stages of the methods described herein can be performed at the battery level or at the system level. Therefore, depending upon the context in which it is used, the materials used for the components of the energy storage devices can be deposited, for example, using chemical vapor deposition, physical vapor deposition, atomic layer deposition, plating, electroless plating, spin coating, and/or other suitable techniques. Similarly, materials for anode, separator, and cathodes of the all-electron energy devices can be designed, for example, using a first principle calculation and/or a hybrid DFT technique.

The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The functions described herein may be implemented in hardware, software executed by a processor, firmware, or any combination thereof. Other examples and implementations are within the scope of the disclosure and appended claims. Features implementing functions may also be physically located at various positions, including being distributed such that portions of functions are implemented at different physical locations.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

It should be emphasized that many variations and modifications can be made to the above-described examples, the elements of which are to be understood as being among other acceptable examples. All such modifications and variations are intended to be included herein within the scope of this disclosure and protected by the following claims. Various other aspects, features, and advantages of the disclosure will be apparent through the detailed description of the disclosure and the drawings attached hereto. It is also to be understood that both the foregoing general description and the following detailed description are examples and are not restrictive of the scope of the disclosure. As used in the specification and in the claims, the singular forms of “a.” “an.” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

I/We claim:

1. An energy storage device, comprising:
an anode having a p-type material;
a cathode having a n-type material; and
a separator disposed between the anode and the cathode,
wherein the separator is composed of an insulating material, and wherein a valence band maximum (VBM) of the p-type material and a conduction band minimum (CBM) of the n-type material fall within an energy band gap of the insulating material.

2. The energy storage device of claim 1 wherein the insulating material of the separator includes a plurality of particles, and wherein individual particles of the plurality of particles have an average diameter ranging from 30 μm to 80 μm.

3. The energy storage device of claim 1 wherein, when the energy storage device is charging, the energy storage device further comprises an interface energy trap at the separator, and wherein the interface energy trap ranges from the VBM of the p-type material to the CBM of the n-type material and comprises an energy level of up to 2-6 kT per electron.

4. The energy storage device of claim 1, further comprising charging carriers including holes and electrons, and wherein, when the energy storage device is charging, the holes and electrons of the charging carriers are trapped in an anode-separator interface and a cathode-separator interface, respectively.

5. The energy storage device of claim 4 wherein, when the energy storage device is discharging, the holes and electrons of the charging carriers are released from the anode-separator interface and the cathode-separator interface.

6. The energy storage device of claim 4 wherein the separator has a higher energy band gap in comparison to the energy band gap of anode and/or the cathode, wherein the separator is configured to prevent recombination of the holes of the charging carriers from the anode and the electrons of the charging carriers from the cathode, and wherein energy band gap value of the separator is from 120% to 300% to energy band gap value of the anode or the cathode.

7. The energy storage device of claim 1 wherein:
at least one of the anode, the cathode, and the separator have a thickness equal to or less than 300 μm; and
at least one of the anode, the cathode, and the separator are composed of oxide materials.

8. The energy storage device of claim 1 wherein:
the anode is composed of materials including silicon, titanium dioxide, tin oxide, and/or nickel oxide;
the separator is composed of materials including silicon dioxide, titanium dioxide, and/or zirconium oxide; and
the cathode is composed of materials including titanium dioxide, bismuth oxide, lead oxide, antimony pentoxide, gallium oxide, lead monoxide, cobalt oxide, tungsten oxide, rubidium oxide, cesium oxide, zinc oxide, mercury oxide, and/or silicon.

9. The energy storage device of claim 1, further comprising a pair of electrically conductive dowel pins and a pair of sealing rings, wherein one of the pair of electrically conductive dowel pins is coupled to the anode via one sealing ring of the pair of sealing rings, and wherein another one of the pair of electrically conductive dowel pins is coupled to the cathode via another sealing ring of the pair of sealing rings.

10. A method of manufacturing an energy storage device, the method comprising:
selecting a p-type anode material and a n-type cathode material from a plurality of candidate materials; and
selecting, based on the selected p-type anode material and the selected n-type cathode material, a separator material from the plurality of candidate materials,
wherein the separator material is insulative and has an energy band gap, and wherein the valence band maximum (VBM) of the p-type anode material and the conduction band minimum (CBM) of the n-type cathode material fall within the energy band gap of the separator material.

11. The method of claim 10 wherein selecting the p-type anode material and the n-type cathode material includes coordinating energy levels of the plurality of candidate materials, the coordinating energy levels of the plurality of candidate materials including:
comparing the VBM of the p-type anode material and the CBM of the n-type cathode material, and
determining the VBM of the p-type anode material being lower than the CBM of the n-type cathode material.

12. The method of claim 11 wherein selecting the separator material from the plurality of candidate materials including coordinating energy levels of the separator material with energy levels of the selected p-type anode material and the selected n-type cathode material, including:
comparing the VBM of the p-type anode material and the CBM of the n-type cathode material with the energy levels of the separator material; and
determining the VBM of the p-type anode material and the CBM of the n-type cathode material both falling within the energy band gap of the separator material.

13. The method of claim 10, further comprising validating the selected p-type anode material, the separator material, and the n-type cathode material using hybrid density functional theory (DFT) calculations with Heyd-Scuseria-Ernzerhof (HSE) exchange-correlation functional.

14. The method of claim 13, further comprising:
obtaining Nyquist curves of the energy storage device in accordance with the validated p-type anode material, separator, n-type cathode material; and
testing the energy storage device based on a charge transfer resistance and a diffusion resistance illustrated on the Nyquist curves.

15. A method of manufacturing an energy storage device, comprising:
preparing a p-type anode;
preparing a separator above the p-type anode;
preparing a n-type cathode; and
assembling the p-type anode, the separator, and the n-type cathode into a cell case and securing the cell case to form the energy storage device,
wherein at least one of the p-type anode, the separator, and the n-type cathode are fabricated using a solution-based evaporation process.

16. The method of claim 15 wherein preparing the p-type anode includes utilizing a silicon wafer having a p-type dopant as the p-type anode, and wherein the silicon wafer has a doping level close to 1 ppm and an ohmic resistance close to 1 ohm/cm.

17. The method of claim 15 wherein the solution-based evaporation process utilized to prepare the separator includes:
preparing insulative oxide powder;
suspending the insulative oxide powder into a first solvent to have the insulative oxide powder mixed therein to form a first solution, the first solvent including a first alcohol, preferably isopropyl alcohol (IPA);
coating the first solution on the p-type anode to form a first coating layer; and
drying the coating layer to evaporate the first solvent to form the separator layer.

18. The method of claim 15 wherein preparing the p-type anode or the n-type cathode includes:
preparing a semiconductor material powder;
suspending the semiconductor material powder into a second solvent to have the semiconductor material powder mixed therein to form a second solution, the second solvent including a secondary alcohol, preferably IPA;
coating the second solution on an electrode to form a second coating layer; and
drying the second coating layer to evaporate the second solvent to form the anode layer as the p-type anode or the cathode layer as the n-type cathode.

19. The method of claim 15 wherein the method further comprises placing the p-type anode, the separator, and the n-type cathode in contact in the energy storage cell case, and wherein the separator is disposed between the p-type anode and the n-type cathode.
